(19) United States
(12) Patent Application Publication
(10) Pub. No.: US 2007/0032184 A1
(43) Pub. Date: Feb. 8, 2007

(54) CRAB LEG MEAT EXTRACTOR

(76) Inventor: Michael James Ciochetti SR., Clayton, GA (US)

Correspondence Address: HARTMAN & HARTMAN, P.C., 552 EAST 700 NORTH, VALPARAISO, IN, 46383, US

(21) Appl. No.: 11/462,236

(22) Filed: Aug. 3, 2006

Related U.S. Application Data
(60) Provisional application No. 60/595,786, filed on Aug. 5, 2005.

(51) Int. Cl. A22C 25/02

(52) U.S. Cl. 452/103

(57) ABSTRACT

A tool for extracting meat from a shell fish, particularly a crab leg. The tool includes a handle, a guide extending from one end of the handle, a tapered blade projecting from the guide in a direction parallel to an operating plane of the tool, and a splitter pivotally attached at a point near the handle and extending at a variable angle to the guide. The tapered blade has a height in the operating plane that decreases in the direction toward a distal tip of the guide, and the splitter is adapted to pivot in the operating plane of the tool and has a slot that is aligned with and sized to receive the tapered blade. The tapered blade enters the slot when the splitter is pivoted in the operating plane toward the guide.

### CROSS REFERENCE TO RELATED APPLICATIONS

This application claims the benefit of U.S. Provisional Application No. 60/595,786, filed Aug. 5, 2005, the contents of which are incorporated herein by reference.

### BACKGROUND OF THE INVENTION

The present invention generally relates to tools adapted for use in extracting meat from crabs and other marine crustaceans. More particularly, this invention relates to an extraction tool capable of removing the meat from a crab leg and splitting the leg open if necessary to remove the meat.

Various tools have been proposed for cutting the shells of shellfish to allow removal if the meat. For example, U.S. Pat. No. 6,503,137 to Maille discloses a utensil with a blade capable of splitting a lobster claw or other part of a shellfish. Another example utensil disclosed in U.S. Pat. No. 6,019,673 to Saizon includes jaws for cracking the shell of shellfish and handles configured for insertion into the cracked shell to extract the meat.

### BRIEF SUMMARY OF THE INVENTION

The present invention provides a tool for extracting the meat from a shell fish. The tool is particularly adapted as a crab leg meat extractor comprising a handle having first and second ends, a guide extending in a longitudinal direction from the second end of the handle, a tapered blade projecting from the guide in a direction parallel to an operating plane of the extractor that is parallel to the longitudinal direction, and a splitter pivotally attached at a point in proximity to the second end of the handle and extending at a variable angle to the guide. The guide has a proximal portion adjacent the second end of the handle and terminates with a distal tip. The tapered blade has a height in the operating plane that decreases in the longitudinal direction toward the tip of the guide. The splitter is adapted to pivot in the operating plane of the extractor and has a slot aligned with and sized to receive the tapered blade. The tapered blade enters the slot when the splitter is pivoted in the operating plane toward the guide.

The crab leg meat extractor as described above is capable of splitting the shell of a shellfish through the operation of the blade alone or with the assistance of the splitter. Furthermore, the guide is preferably adapted to extract the meat from a shellfish, especially a crab leg, by inserting the guide into the meat-filled hollow interior of the leg. Also from the above, it can be seen that the extractor is conducive to uncomplicated manufacture and use. When used to extract the meat from a crab leg, the user holds the extractor by the handle, inserts the guide into the interior of the leg, and forces the guide through the crab leg, causing the guide to force the meat from the interior of the leg while simultaneously splitting the leg open with the tapered blade. If a region of the crab leg is encountered that is more difficult to split with the tapered blade, such as a knuckle, by pivoting the splitter toward the guide the user can cause the portions of the splitter separated by the slot to forcibly engage the crab leg on opposite sides of the tapered blade, which then more readily splits the engaged region of the leg.

Other objects and advantages of this invention will be better appreciated from the following detailed description.

### BRIEF DESCRIPTION OF THE DRAWINGS

FIGS. 1, 2, and 3 are side, top, and end views, respectively, of a crab leg meat extractor in accordance with a preferred embodiment of the invention.

### DETAILED DESCRIPTION OF THE INVENTION

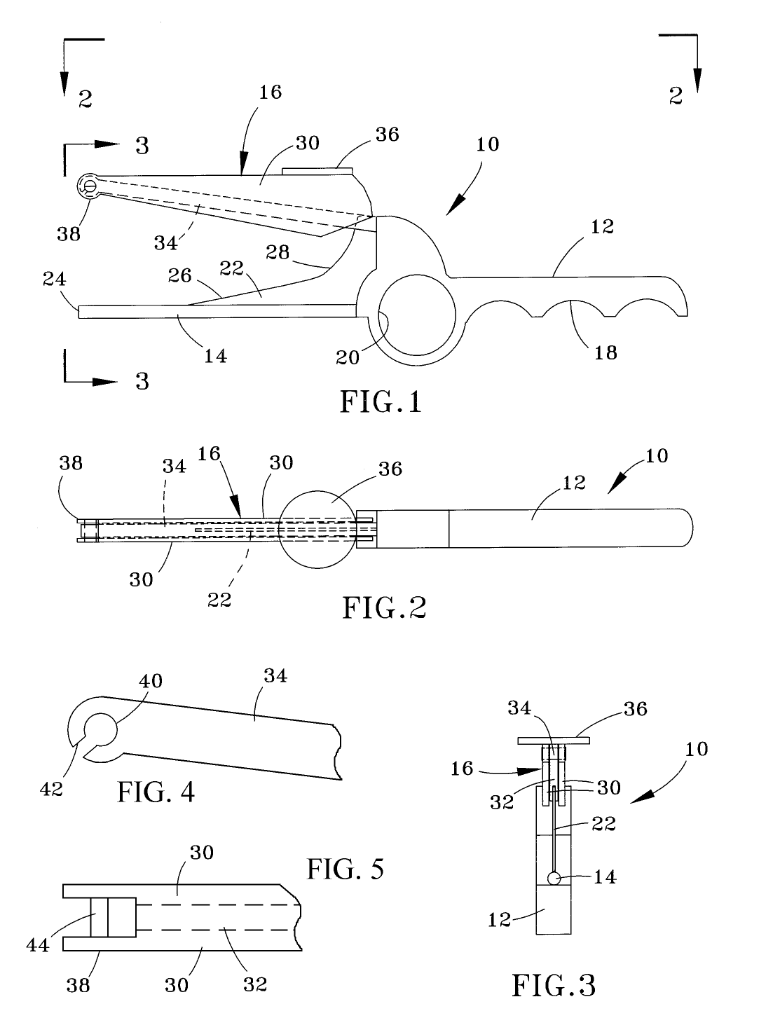

A crab leg meat extractor 10 according to a preferred embodiment of this invention is Illustrated in FIGS. 1 through 3. While described in reference to extracting meat from a crab leg, it will be appreciated that the extractor 10 can be used to crack or split the shells and/or extract the meat of a variety of shellfish, and therefore should not be viewed as limited to use on crab legs.

As shown in the Figures, the extractor 10 has a grip or handle 12, a guide 14 longitudinally extending from the handle 12, and a splitter 16 capable of being pivoted relative to the guide 14. In its free state, the splitter 16 preferably extends at an acute angle (e.g., about ten to fifteen degrees) to the guide 14. Both the guide 14 and splitter 16 lie in a plane that will be referred to as the operating plane of the extractor 10, and the splitter 16 pivots in the operating plane relative to the guide 14. The handle 12 is presented as having a scalloped lower surface 18 to receive the fingers of a user, and a finger hole 20 sized to receive the user's index finger.

The guide 14 generally has a circular cross-section (FIG. 3) that is preferably sized for being received in the hollow interior of a crab leg, e.g., on the order of about 3/16 inch (about 4 to about 5 mm). A tapered blade 22 extends from the guide 14 toward the splitter 18 and lies in the operating plane of the extractor 10. The height of the tapered blade 22 is sufficient to protrude through a crab leg in which the guide 14 is received, and thereby splits the crab leg as the guide 14 is forced through the meat-filled hollow interior of the leg. For this purpose, the blade 22 preferably has a width of about 1/16 inch (about 1 to about 2 mm) and is preferably continuous on the guide 14 starting at a point adjacent the handle 12 and continuing to a point short of a distal tip 24 of the guide 14, e.g., about three-quarters of the length of the guide 14 as represented in FIG. 1. The height of the blade 22 decreases toward the tip 24 of the guide 14, and is preferably defined by a linear portion 26 that tapers at an acute angle (e.g., about ten degrees) relative to the longitudinal direction of the guide 14 and an arcuate portion 28 between the linear portion 26 and the end of the handle 12.

The splitter 16 is preferably pivotally attached to the handle 12 at a point generally coinciding with the location where the guide 14 joins the handle 12. The pivoting connection between the splitter 16 and the handle 12 can be, for example, through a beam 34 that elastically bends when the splitter 16 is pivoted, though it is foreseeable that a wide variety of functionally-equivalent structures could be used to provide the desired pivoting action between the splitter 16 and handle 12, such as a spring-loaded hinge. In the embodiment shown in the Figures, the beam 34 is formed as an integral extension of the handle 12, while the splitter 16 is formed separately and removably assembled to the beam 34 to allow disassembly and cleaning of the extractor 10. As shown in FIGS. 4 and 5, which are details of the end of the beam 34 and the end 38 of the splitter 16, respectively, the beam 34 is formed to have a circular bore 40 and a radial slot 42, and the end 38 of the splitter 16 has a circular bar 44 sized to snap-fit through the slot 42 into the bore 40 of the beam 34 to secure the splitter 16 to the beam 34. While this attachment technique is believed to be well suited for its purpose, various other techniques could be employed to secure the splitter 16 to the beam 34. Alternatively, it is foreseeable that the splitter 16 could be formed as an integral part of the handle 12 along with the beam 34, or the splitter 16 itself could be configured to incorporate the function of the beam 34.

A thumb depressor pad 36 is preferably defined on the splitter 16 by which the user can pivot the splitter 16 toward the guide 12 using the user's thumb. As such, the pad 36 is preferably sized (e.g., about 2.5 cm in diameter) to accommodate a human thumb and lies in a plane transverse to the operating plane of the extractor 10. The splitter 16 has a pair of parallel walls 30 that form a slot 32 therebetween that is aligned and generally coplanar with the blade 22 on the guide 14, so that the blade 22 will enter the slot 32 when the splitter 16 is pivoted in the operating plane toward the guide 14.

As described above, it should be apparent that the extractor 10 can be produced by individually manufacturing (machining, molding, etc.) and assembling its components, or by molding the extractor 10 as a complete unit. Suitable materials for the extractor 10 will depend on the chosen manufacturing approach, but generally include metals and rigid plastics of types used for cooking utensils.

In use, the user holds the extractor 10 by its handle 12, with the user's index finger within the finger hole 20, thumb resting on the pad 36, and remaining fingers gripping the scalloped lower surface 18. While holding a crab leg, the user inserts the guide 14 into the hollow interior of the leg and forces the guide 14 through the leg, causing the guide 14 to force the meat out of the leg as the tapered blade 22 splits the leg open. If a region of the crab leg is encountered that is more difficult to split with the blade 22, the user can press the thumb depressor pad 36 on the splitter 16 to cause the splitter 16 to pivot toward the guide 14, causing the walls 32 to engage the crab leg on opposite sides of the blade 22 with sufficient force to split the leg where engaged.

While the invention has been described in terms of a preferred embodiment, it is apparent that other forms could be adopted by one skilled in the art. For example, the physical configuration and appearance of the extractor 10 could differ from that shown, and materials and processes other than those noted could be use. Therefore, the scope of the invention is to be limited only by the following claims.

1. A crab leg meat extractor comprising:
a handle having first and second ends;
a guide extending in a longitudinal direction from the second end of the handle, the guide having a proximal portion adjacent the second end of the handle and terminating with a distal tip;
a tapered blade projecting from the guide in a direction parallel to an operating plane of the crab leg meat extractor that is parallel to the longitudinal direction, the tapered blade having a height in the operating plane that decreases in the longitudinal direction toward the tip of the guide; and
a splitter pivotally attached at a point in proximity to the second end of the handle and extending at a variable angle to the guide, the splitter pivoting in the operating plane of the crab leg meat extractor and having a slot aligned with the tapered blade and sized to receive the tapered blade, wherein the tapered blade enters the slot when the splitter is pivoted in the operating plane toward the guide.

2. The crab leg meat extractor according to claim 1, wherein the guide has a length as measured from the second end of the handle to the distal tip of the guide, and the tapered blade projects from the guide starting at the proximal portion of the guide, continues along the length of the guide, and terminates short of the distal tip of the guide.

3. The crab leg meat extractor according to claim 2, wherein the tapered blade projects from the guide along approximately three-quarters of the length of the guide.

4. The crab leg meat extractor according to claim 2, wherein the tapered blade has a linear portion that tapers at an acute angle relative to the longitudinal direction of the guide and an arcuate portion between the linear portion and the second end of the handle.

5. The crab leg meat extractor according to claim 1, wherein the guide is collinear with the handle.

6. The crab leg meat extractor according to claim 1, wherein the guide has a cross-section sized to be received within the interior of the crab leg.

7. The crab leg meat extractor according to claim 6, wherein the cross-section of the guide is circular.

8. The crab leg meat extractor according to claim 6, wherein the height of the tapered blade is sufficient to protrude through the crab leg in which the guide is received and thereby split the crab leg as the guide is forced through the interior thereof.

9. The crab leg meat extractor according to claim 1, wherein the handle comprises a finger hole therethrough located at the second end of the handle.

10. The crab leg meat extractor according to claim 9, wherein the finger hole has an axis transverse to the operating plane of the crab leg meat extractor.

11. The crab leg meat extractor according to claim 1, wherein the slot of the splitter is defined by a pair of spaced-apart walls projecting toward the guide.

12. The crab leg meat extractor according to claim 1, wherein the splitter comprises a thumb depressor pad sized to accommodate a human thumb and lying in a plane transverse to the operating plane of the crab leg meat extractor.

13. The crab leg meat extractor according to claim 12, wherein the plane of the thumb depressor pad is parallel to the longitudinal direction of the guide.

14. A crab leg meat extractor comprising:
a handle having first and second ends;
a guide collinearly extending in a longitudinal direction from the second end of the handle, the guide having a circular cross-section sized to be received within the interior of the crab leg, having a proximal portion adjacent the second end of the handle, and terminating with a distal tip;
a tapered blade projecting from the guide in a direction parallel to an operating plane of the crab leg meat extractor that is parallel to the longitudinal direction, the tapered blade having a height in the operating plane that decreases in the longitudinal direction toward the tip of the guide, the height of the tapered blade being sufficient to protrude through the crab leg in which the guide is received and thereby split the crab leg as the guide is forced through the interior thereof; and
a splitter pivotally attached at a point in proximity to the second end of the handle and extending at a variable angle to the guide, the splitter pivoting in the operating plane of the crab leg meat extractor and having a slot aligned with the tapered blade and sized to receive the tapered blade, wherein the tapered blade enters the slot when the splitter is pivoted in the operating plane toward the guide.

15. The crab leg meat extractor according to claim 14, wherein the guide has a length as measured from the second end of the handle to the distal tip of the guide, and the tapered blade projects from the guide starting at the proximal portion of the guide, continues along the length of the guide, and terminates short of the distal tip of the guide.

16. The crab leg meat extractor according to claim 15, wherein the tapered blade projects from the guide along approximately three-quarters of the length of the guide.

17. The crab leg meat extractor according to claim 15, wherein the tapered blade has a linear portion that tapers at an acute angle relative to the longitudinal direction of the guide and an arcuate portion between the linear portion and the second end of the handle.

18. The crab leg meat extractor according to claim 14, wherein the handle comprises a finger hole therethrough located at the second end of the handle, the finger hole having an axis transverse to the operating plane of the crab leg meat extractor.

19. The crab leg meat extractor according to claim 14, wherein the slot of the splitter is defined by a pair of spaced-apart walls projecting toward the guide.

20. The crab leg meat extractor according to claim 14, wherein the splitter comprises a thumb depressor pad that lies in a plane transverse to the operating plane of the crab leg meat extractor and parallel to the longitudinal direction of the guide, the thumb depressor pad being sized to accommodate a human thumb.
